(19) United States
(12) Patent Application Publication
(10) Pub. No.: US 2023/0219050 A1
(43) Pub. Date: Jul. 13, 2023

(54) Method For Preparing Raspberry Nanoparticles

(71) Applicant: Surfactis Technologies, Angers (FR)

(72) Inventors: Olivier Favrat, Angers (FR); David Portet, Briollay (FR)

(73) Assignee: Surfactis Technologies, Angers (FR)

(21) Appl. No.: 17/766,402

(22) PCT Filed: Oct. 5, 2020
(86) PCT No.: PCT/EP2020/077866

§ 371 Date: Apr. 4, 2022

(30) Foreign Application Priority Data
Oct. 4, 2019 (EP) 19306287.4

(51) Int. Cl. B01J 13/20

(52) U.S. Cl. CPC B01J 13/20

(57) ABSTRACT

The present invention relates to a method for preparing a dispersed suspension of nanoparticles called “raspberry nanoparticles” having a diameter of less than or equal to 130 nm, the raspberry nanoparticles being optionally functionalised with a hydrophobic organic molecule. The present invention also relates to a suspension which comprises the raspberry nanoparticles and can be produced by the method and to the use thereof for making a surface superhydrophobic or superhydrophilic, depending on whether the nanoparticles are functionalised with a hydrophobic organic molecule. Finally, the present invention relates to a method for covering the surface using a suspension according to the invention in one single step.

### FIELD OF THE INVENTION

The present invention relates to a method for preparing a dispersed suspension of so-called «raspberry» nanoparticles having a diameter less than or equal to 130 nm, the raspberry nanoparticles optionally being functionalised with a hydrophobic organic molecule. The present invention also relates to a suspension comprising said raspberry nanoparticles obtainable by said method, and to the use thereof for making a surface superhydrophobic or superhydrophilic depending on whether the nanoparticles are or are not functionalised with a hydrophobic organic molecule. Finally, the present invention relates to a surface coating method using a suspension of the invention, in a single step.

### DESCRIPTION OF THE PRIOR ART

Obtaining superhydrophilic or superhydrophobic surfaces is a challenge that has been addressed in the scientific literature for about fifteen years. These phenomena are dependent on:

i) hierarchical surface roughness on several length scales (J. Song et al. 2012 Chemical Engineering Journal), and
ii) hydrophilic surface chemistry for superhydrophilic surfaces, or hydrophobic surface chemistry for superhydrophobic surfaces as described in application WO2015177229 (also published under number US 2017/120294).

To control surface roughness there are several approaches. So-called «top-down» approaches in which a surface is etched to form roughness in the form of spikes, needles or pillars (Yan et al. 2011 Advances in Colloid and Interface Science; Celia et al. 2013 J Colloid Interface Science). With this method, etching can be performed using several techniques which provide control over the depth and geometry of the formed roughness. These techniques are generally fairly cumbersome to carry out for simple obtaining of desired roughness over extensive surfaces. In addition, several steps must be performed to texturize and then make the surface hydrophobic.

In the other «bottom-up» method, material is added to smooth surfaces to impart roughness thereto (Liu et al. 2015 Ceramics International, Ming et al. 2005 Nanoletters). In this case, it is possible to deposit objects of different size on these surfaces to ensure the roughness thereof. The difficulty with this technique is control over the deposited objects and hence control over roughness.

To obtain a superhydrophobic effect, and to a lesser extent a superhydrophilic effect, sufficient roughness is required. The theory which emerged from investigation of lotus leaves (Gao et al. 2006 Langmuir), indicates that it is preferable for roughness to have two length scales: micrometric and nanometric for example. An organised stack of particles of adapted size for example allows this effect to be reached. However, the particles used must be of sufficient size to ensure the superhydrophilic or superhydrophobic effect.

This issue of control over roughness is also of importance when transparency of the surface is at stake. Roughness distorts transmission of light (Mie theory). Objects of size larger than □/4 promote scattering of incident wavelength □. To avoid promoting this phenomenon in the visible range (□>400 nm), the objects used to obtain surface roughness must not exceed a diameter of 100 nm. In practice, surfaces are not perfectly planar and objects not ideally spherical. Results in the literature show that objects having a diameter of 130 nm do not or only scarcely deteriorate the optical performance of a surface (Portet et al. WO2015177229). Therefore, the size of the objects, typically particles, must be less than or equal to 130 nm.

To bypass this issue, one method is to form hollow spheres coated with particles of small size, the core of the particle then being dissolved. This provides particles of larger size without perturbing light transmission because of the hollow portion of the particle. The synthesis of these particles follows cumbersome and complex techniques difficult to implement on industrial scale (Vollmer et al. WO2012107406).

Another technique is to synthesise the particles in situ using the Stöber method to provide the second scale of roughness on particles of large size. In this case it is possible to grow silica nanoparticles, the growth thereof being limited by the addition of a fluorinated agent (Zheng-Bai Zhao et al. 2016 Ceramics International, Vollmer et al. WO2012107406) and by the concentration of silica precursor (TEOS). It is difficult to anticipate and control the size of the secondary particles thus formed. Raspberry nanoparticles (RNPs) have been used to roughen surfaces for the purpose of making them superhydrophobic. The process for producing raspberry particles requires several successive sometimes complex steps, at which there is a risk of the particles aggregating, in particular if they are of small size, typically smaller than 150 nm. Once the particles have aggregated together, their de-aggregation is difficult and even impossible.

In almost all the literature, raspberry nanoparticles have sizes greater than 130 nm. In the other cases, the literature proposes polydisperse mixtures of large-size particles and small-size nanoparticles including smaller than 100 nm. These mixtures of particles cannot lead to integral transmission of incident light.

To synthesise raspberry particles of diameter less than or equal to 130 nm before they are applied to surfaces, recourse must be had to populations of individualised particles of smaller size. If it is considered that several populations of particles are able to coexist to form RNPs, then the smallest of these populations must have a maximum theoretical diameter of less than 50 nm.

To obtain raspberry particles of very small size (less than 130 nm), the literature describes syntheses in which successive preparation steps of said particles are performed directly on the surface of a material to be coated (Karunakaran et al.; 2011 Langmuir). In this case, the author circumvents the problem of agglomeration of nanoparticles of small size. The synthesis steps at which particles can agglomerate are limited since, once each population of nanoparticles has been deposited on a surface, it is no longer mobile and can no longer form aggregates. This type of method requires complex, at times lengthy, preparation of the surface to obtain the desired coating of nanoparticles. Additionally, one simple means for handling nanoparticles by controlling their surface chemistry is the depositing thereof in dry form. That is to say a state in which the particles are not solvated. However, in this state, the particles of small size have a tendency to aggregate to form groups of particles of larger sizes. The prior results obtained by our team (WO2015177229) point in this direction. They show surface transparency when RNPs of 130 nm are applied. However, the method required drying of the particles which generated the onset of aggregates that were impossible to remove. In addition, the hydrophilic nature of the particles only allowed good suspension in conventional organic solvents. As a result, with these former methods, it was necessary to perform surface treatment in two steps (depositing of particles followed by depositing of hydrophobic molecules on the rough surface) to obtain a superhydrophobic and transparent effect. On the contrary, the present surface coating method only requires the application to the surface of a single suspension containing all the nanoparticles.

To date, no study has described nanoparticles of size less than 50 nm able to be de-agglomerated with simple methods (Sui et al. 2018 Ceramic International; Kamaly et al. 2017 Adv. Powder Technology). In particular, it has never been shown that it is possible to provide dry, dispersed particles of diameter less than 50 nm for use thereof in the production of RNPs. It has therefore never been proposed to synthesise raspberry nanoparticles of 130 nm or smaller with this synthesis mode.

While the dispersion of dry particles is problematic, there is no description in the literature either of raspberry nanoparticles obtained by wet process i.e. from particles that are never desolvated and having dispersion such that they allow the obtaining of a stable suspension of raspberry nanoparticles of diameter <130 nm whilst having good dispersion. As shown in Examples 6 and 8 of the present application and in FIG. 6, the suspensions obtained using nanoparticles that have been dried (for example following the protocol described in WO2015177229) are not stable and they contain agglomerates causing turbidity.

There is therefore a need for a method of preparing raspberry nanoparticles of small size, typically less than 130 nm, preventing aggregation thereof and allowing simple, direct application to a non-treated surface to obtain a coating of raspberry nanoparticles in a single step, in particular to make the surface superhydrophobic or superhydrophilic.

The suspensions obtained following the protocol of the present application do not contain any agglomerates as demonstrated by measurements of hydrodynamic diameters described in Example 9 below. They therefore differ structurally from the suspensions obtained following the method described in WO2015177229.

Depositing these particles onto surfaces in a single step is a major criterion for industrialization of the method. Document WO2015177229 describes the preparation of raspberry nanoparticles via electrostatic route. They are deposited on the surface and a fluorinated agent is evaporated at a second step to impart the superhydrophobic nature to this surface. It is impossible to implement this method in a single step via liquid process since this requires the addition of the hydrophobic agent to a liquid medium which deteriorates the stability of the raspberry nanoparticles obtained via electrostatic route. These particles are not recommended for application in a single step for a superhydrophobic coating. It is therefore necessary to use raspberry particles that are durably grafted. Covalent grafting can meet this need.

In the current state of knowledge, these different constraints do not allow the fabrication of raspberry nanoparticles of less than 130 nm formulated in a dispersed state. In addition, some methods are not compatible with restrictions inherent in industrial applications. In particular, they are not adapted for the treatment of transparent surfaces with a view to making them superhydrophilic or superhydrophobic.

For the first time, the present inventors describe a preparation method allowing dispersed suspensions of raspberry nanoparticles to be obtained, whether or not hydrophobized, of size less than or equal to 130 nm, ready for use to obtain a superhydrophobic or superhydrophilic coating on a non-treated surface, in a single step and at ambient temperature.

The inventors sought to obtain particles that are dispersed in one or more solvents and having formulations that are sufficiently stable over time so that they can be applied to surfaces in a single step.

### SUMMARY OF THE INVENTION

A first subject of the invention is a method for preparing a suspension comprising «raspberry» nanoparticles having a diameter of size X+2Y, each raspberry nanoparticle being composed of a nanoparticle having a diameter of size X on the surface of which nanoparticles having a diameter of size Y are covalently grafted,

said method comprising at least the following successive steps:
(a) Obtaining a suspension comprising nanoparticles having a diameter of size X in an aprotic solvent S1;
(b) Adding an adhesion promoter to the suspension obtained after step (a);
(c) Adding the reaction medium obtained after step (b) directly to a suspension comprising nanoparticles having a diameter of size Y dispersed in an aprotic solvent S1′, leading to the formation of raspberry nanoparticles having a diameter of size X+2Y;
(d) Optionally, adding a solvent S2 to the reaction medium obtained after step (c), then partially or fully removing solvent S1 and/or S1′, preferably by centrifugation;
(e) Recovering a suspension of raspberry nanoparticles having a diameter of size X+2Y dispersed in solvent S1, S1′, S2 or mixtures thereof,
   characterized in that the nanoparticles having a diameter of size X or Y and the raspberry nanoparticles are kept dispersed in liquid medium throughout all the steps of the method, and in that the diameter X+2Y of the raspberry nanoparticles is less than or equal to 130 nm.

In this method, at least one of the diameters X or Y is of size less than 50 nm.

The particles are kept in liquid medium throughout the method to prevent agglomeration thereof. A second subject of the invention relates to a suspension able to be obtained or directly obtained with the method of the invention such as described above, and to the use thereof to make a surface superhydrophilic.

Additionally, the method of the present invention also allows the preparation of «raspberry» nanoparticles having a diameter X+2Y less than or equal to 130 nm functionalised with at least one hydrophobic organic molecule when said method comprises the steps (a) to (e) and, after step (e), comprises the following successive steps (f) and (g):
(f) Adding a hydrophobic organic molecule comprising a grafting function to the suspension recovered at step (e);
(g) Recovering a suspension of raspberry nanoparticles having a diameter of size X+2Y less than or equal to 130 nm functionalised with at least one hydrophobic organic molecule in solvent S1, S1′, S2 or mixtures thereof.

The present invention therefore also concerns a suspension able to be obtained or directly obtained with the method of the invention comprising steps (a) to (g) and to the use thereof to make a surface superhydrophobic.

A final subject of the invention concerns a method for coating a surface whereby a suspension of the invention is deposited on a surface in a single step.

### DETAILED DESCRIPTION OF THE INVENTION

### Method for Preparing Raspberry Nanoparticles

The method of the present invention allows the obtaining of a suspension comprising so-called «raspberry» nanoparticles having a total diameter denoted X+2Y less than or equal to 130 nm. In the present invention, the term «size» of a nanoparticle designates the diameter thereof.

By «suspension» in the present invention, it is meant a mixture in which the dispersing phase is liquid and the dispersed phase is solid. In the meaning hereof, the suspension is colloidal, the dispersed phase therefore does not or only scarcely sediments in the dispersing phase.

By «nanoparticle» (or NP) in the present invention, it is meant spherical solid particles of very small size, typically of nanometric size. More specifically, the «nanoparticles» able to be used in the method of the invention have a mean diameter of between 5 nm and 100 nm.

By «good dispersion», it is meant that the particles have a size of less than twice their nominal size when measured by dynamic light scattering for example. If this value is heeded, this means that no agglomerate of large size is obtained in the suspension. One of the consequences of good dispersion of nanoparticles of size less than 130 nm is to obtain a homogeneous colloidal suspension.

By «population of nanoparticles» in the present invention, it is meant a group of nanoparticles of same size or similar size i.e. having the same shape and homogeneous size distribution. In practice, the diameter of the nanoparticles within one same population follows a Gaussian distribution which may vary by no more than 30%.

By «raspberry nanoparticle» (or RNP), it is meant a nanoparticle having a diameter of size X on which there are grafted nanoparticles having a diameter of size Y so that the nanoparticles of size Y coat the surface of the nanoparticles of size X. The nanoparticle of size X therefore forms the core of the raspberry nanoparticle. Coating can be entire so that the entirety of the surface of the nanoparticle of size X is coated, or preferably coating can be partial so that the nanoparticle of diameter X is not fully coated by particles of diameter Y, to maximise the roughness of the raspberry nanoparticle. In the context of the present invention, the nanoparticles having a diameter of size Y are covalently grafted onto the surface of the nanoparticles having a diameter of size X. The total diameter of the resulting raspberry nanoparticles is therefore X+2Y.

In the present invention, the total diameter of the raspberry nanoparticles obtained with the method is less than or equal to 130 nm, preferably it is between 30 nm and 100 nm, further preferably it is between 50 nm and 100 nm. Advantageously the raspberry nanoparticles derived from the method of the invention have a total diameter of between 50 and 80 nm.

Typically, the diameters X and Y are each between 5 nm and 100 nm, more preferably between 10 nm and 80 nm, and further preferably between 10 nm and 50 nm. The diameters X and Y are chosen so that X+2Y is never greater than 130 nm.

In the present invention, the ratio of the size of particles X to the size of particles Y is typically between 1 and 30, for example between 2 and 30, preferably between 3 and 10. In other words, the diameters X and Y can be the same. Preferably diameter X is greater than diameter Y. The nanoparticle of size X at the core of the raspberry nanoparticle is therefore typically larger than the nanoparticles of size Y grafted onto the surface thereof.

In one particular embodiment of the present invention, the nanoparticles are composed of a material selected from among:
inorganic materials (e.g. silicon, aluminium, titanium, zinc, germanium and/or the oxides and/or alloys thereof;
metals, alloys, oxides and ceramics or carbon-containing composites; and
polymers among which: polycarbonate, polyethylene terephthalate (PET), polymethyl methacrylate (PMMA), polystyrene, polyethylene, polyesters, poly(acrylic acid) (PAA), polyacrylamide (PAM), polyalkyl acrylate, polymethyl acrylate (PMA), polyethyl acrylate (PEA), polybutyl acrylate (PBA) and latex.

The nanoparticles can also be composed of a single compound or an alloy of several compounds of different types.

The nanoparticles of size X and nanoparticles of size Y can each be composed of a different material or they may be composed of the same material. Advantageously, they are composed of the same material.

Preferably, the nanoparticles are composed of an inorganic material selected from among silicon, aluminium, titanium, zinc, germanium, and/or the oxides and/or the alloys thereof.

Step (a)

At step (a), the nanoparticles of size X are placed in suspension and dispersed in an aprotic solvent denoted S1.

By «aprotic» it is meant a solvent not containing an acidic hydrogen atom these generally being bonded to a heteroatom such as nitrogen N, oxygen O or sulfur S. This aprotic solvent does not therefore contain a hydrogen atom likely to be released from the solvent molecule to interact with the molecules of the method.

By «dispersed» it is meant particles that are not or only scarcely agglomerated in suspension in a solvent. The consequence of good dispersion of the particles is that the colloidal suspension does not settle. The dispersion of a suspension can be verified by measuring the mean hydrodynamic radius or diameter. The mean hydrodynamic radius is the radius of a theoretical sphere which would have the same scattering coefficient as the particle under consideration. A mean hydrodynamic radius or diameter close to the real radius or diameter of the nanoparticles indicates good dispersion thereof within the solvent. The more the mean hydrodynamic radius or diameter is greater than the real size of the nanoparticles the more the suspension will comprise agglomerates of nanoparticles. The mean hydrodynamic radius or diameter can be measured by dynamic light scattering using Zetasizer apparatus for example.

Good dispersion can also be assessed by observing the suspension of nanoparticles. This suspension must be visually homogeneous and not exhibit any deposit on the edges or at the bottom of the flask in which it is contained.

Solvent S1 advantageously ensures stability of the suspension of particles to prevent aggregation and precipitation of the nanoparticles. In particular, it allows solubilisation of the adhesion promoter added at following step (b). In addition, solvent S1 is advantageously inert against reactive functions present on the surface of the nanoparticles or those belonging to the adhesion promoter. Solvent S1 is preferably anhydrous.

Preferably, solvent S1 is a polar aprotic solvent. For example, it can be selected from among methoxy propyl acetate (PMA), acetone, butanone (or methyl ethyl ketone denoted MEK), butyl acetate, methyl isobutyl ketone (MIBK), or butyl glycol acetate (BGA).

Solvent S1 can also be an apolar aprotic solvent or weakly polar aprotic e.g. toluene or xylene By «polar» it is meant a solvent having a nonzero dipolar moment. It must also be capable of creating interactions of Van der Waals or hydrogen type with other polar compounds, as are the constituent elements of the particles of the invention.

In one particular embodiment, the nanoparticles of size X are placed in suspension and dispersed in solvent S1 at a concentration of between 1 g/L and 400 g/L. Preferably, this concentration is between 20 g/L and 300 g/L.

Dispersing of the nanoparticles can be performed mechanically, for example using a mechanical or ultrasonic agitator.

In parallel, in another container, the nanoparticles of size Y are placed in suspension in solvent S1′ having the same properties as solvent S1. Preferably, S1′ is a polar aprotic solvent. For example, it can be selected from among methoxy propyl acetate (PMA), butanone (or methyl ethyl ketone denoted MEK), butyl acetate or methyl isobutyl ketone (MIBK).

Preferably, solvent S1 and solvent S1′ are the same.

In one particular embodiment, the nanoparticles of size Y are placed in suspension in solvent S1′ at a concentration of between 1 g/L and 400 g/L. Preferably, this concentration is between 20 g/L and 300 g/L.

Before being placed in suspension in the respective solvents S1 and S1′, the populations of nanoparticles of size X and size Y can each be in a solvent S0 and S0′, preferably the same, having a boiling point lower than that of S1 and S1′ respectively. These solvents S0 and S0′ are not necessarily aprotic. If the particles are of size less than 50 nm, at the time of transfer of the nanoparticles to the respective solvents S1 and S1′, said nanoparticles must at all times remain in liquid medium. The nanoparticles must therefore never be desolvated. For this purpose, solvent S1 is added to the solution comprising the nanoparticles of size X in solvent S0, and the mixture is then distilled to evaporate solvent S0 and to obtain the suspension of nanoparticles of size X solely in solvent S1. When distilling, part of solvent S1 may also be evaporated. The same process is applied to obtain nanoparticles of size Y in solvent S1′ by removing solvent S0′.

Good dispersion of the nanoparticles in the suspension is essential so that they are able to react with the adhesion promoter at the following steps. Drying of the nanoparticles before or during the method of the invention causes agglomeration thereof. On account of the small size of the particles, the power required for subsequent redispersion in liquid medium of those having a size smaller than 50 nm then becomes greater than the power able to be provided by apparatus useful for this purpose such as a mechanical agitator or ultrasound probe for example. Drying of these nanoparticles is therefore to be avoided.

The method of the invention preferably does not comprise a drying step of the nanoparticles at any time whatsoever. It is especially important not to dry nanoparticles of small size (<50 nm), since the resulting aggregates can no longer be removed. This characteristic sets the method of the invention apart from prior art methods, in particular the one described in international application WO2015177229.

In the event of poor dispersion, aggregates of particles of diameter greater than 130 nm would be present in the dispersing medium. Good dispersion of the small-size particles (<50 nm) in a suitable solvent is therefore a key factor for the success of subsequent formation steps of raspberry nanoparticles and good dispersion thereof in suspension.

Step (b):

At step (b), an adhesion promoter is added to the suspension of nanoparticles having a diameter of size X in solvent S1. The nanoparticles of size X are then coated with said adhesion promoter after step (b).

In the context of the present invention, an «adhesion promoter» is an organic chemical compound allowing the setting up of a strong interaction, in particular a covalent bond, between the nanoparticles of size X and those of size Y which will be deposited on the latter. Said adhesion promoters are for example dissymmetric organic molecules carrying two functions allowing sequential reaction with particles. Said adhesion promoters are preferably compounds of organic monomers comprising functions allowing ensured affinity between the different populations of nanoparticles, for example a reactive chemical group allowing the formation of covalent bonds. Therefore, the adhesion promoter will react with the reactive functions present on the surface of the nanoparticles of size X, and at a second stage with the reactive functions present on the surface of the nanoparticles of size Y when these are added at the following step, to form a covalent bond between the nanoparticles of size X and the nanoparticles of size Y.

Preferably, the adhesion promoter is an alkoxysilane or a chlorosilane carrying a reactive function, preferably an isocyanate function. It is preferably an isocyanate silane compound such as 3-(Trimethoxysilyl)propyl isocyanate (TMS-NCO) and 3-(Triethoxysilyl)propyl isocyanate. Mention can also be made of epoxide silane compounds such as 3-Glycidoxypropyltrimethoxysilane (GPTMS) or 3-Glycidoxypropyltriethoxysilane. More preferably the adhesion promoter is TMS-NCO.

The adhesion promoter is typically added to the suspension of nanoparticles of size X in solvent S1 derived from step (a) at a concentration of between 10⁻⁵ mol/L and 1 mol/L, preferably between 10³ and 10⁻¹ mol/L.

Typically, it is added in excess or in stoichiometric amount relative to the nanoparticles having a diameter of size X, i.e. relative to the reactive functions typically OH groups present on the surface of the nanoparticles. When added in large excess, steps of successive centrifugations, dialysis or filtration, and removal of the supernatant containing the adhesion promoter in excess are performed at the end of step (b) to remove non-reacted adhesion promoter. Solvent S1 is then re-added to maintain the same nanoparticle concentration. When added in stoichiometric amount or in slight excess (less than 1.5 times the stoichiometric amount), a purification step by centrifugation, dialysis or filtration is not necessary. Preferably, the adhesion promoter is added in stoichiometric amount. The resulting reaction medium is then advantageously left under agitation for a time of between 1 hour and 24 hours, preferably for 12 hours to 18 hours, typically at a temperature of between 10° C. and the boiling point of the solvent, preferably at a temperature of between 17° C. and 30° C.

The inventors have found that a contact time that is too short (typically less than 1 hour) between the nanoparticles of size X and the adhesion promoter does not allow sufficient functionalisation of the nanoparticles for subsequent ensured bonding between the particles of different sizes. A contact time that is too long (typically longer than 24 hours) leads to the reacting together of the nanoparticles of size X. Too lengthy contact time can also lead to hydrolysis of the reactive functions on the surface of the nanoparticles. In all these cases, the forming of raspberry nanoparticles can no longer be envisaged.

Step (c):

At step (c), the reaction medium obtained after step (b) is added to the suspension comprising nanoparticles of size Yin solvent S1′.

The reactive functions, typically OH functions, present on the surface of the nanoparticles of size Y will react with the reactive groups of the adhesion promoter attached to the surface of the nanoparticles of size X, and thereby form raspberry nanoparticles having a diameter of size X+2Y. The nanoparticles having a diameter of size Y are advantageously added in excess relative to the nanoparticles having a diameter of size X.

The nanoparticles having a diameter of size Y are typically added in a ratio N.

Ratio N allowing the nanoparticles of size Y to fully coat the nanoparticles of size X (in a single layer) preferably meets the following formula:

$$N = \frac{{π ( Y / 2 + X / 2 )}^{2}}{{( Y / 2 )}^{2}}$$

where X corresponds to the diameter of the core nanoparticles and Y to the diameter of the outer nanoparticles.

The inventors have shown that grafting is never entire in this embodiment of the invention, even when the ratio is higher than N. This makes it possible to maximise roughness of the raspberry nanoparticles while preventing entire coating thereof by nanoparticles of size Y. An entirely coated particle will have secondary roughness having half the value of grafting performed without secondary particles, this secondary roughness possibly reaching Y.

Nonetheless, the coexistence of raspberry nanoparticles of size X+2Y and of nanoparticles of size Y within the suspension can improve surface roughness. It is therefore useful to maintain the spherical particles of size Y in excess not grafted to the raspberry nanoparticles in the same suspension as the formed raspberry nanoparticles. Once the formulation is applied to a surface, coating with this mixture of RNPs and of nanoparticles of size Y ensures more complete coating than when composed solely of RNPs. This coating acts as interface between the treated surface and the outer liquid or gaseous medium.

In one embodiment of the invention, the quantity of nanoparticles of size Y will therefore be between N/10 and 2N, preferably between N/5 and N for each particle of size X.

For example, for nanoparticles of size Y=15 nm and of size X=50 nm, N=59. Preferably between 12 and 59 nanoparticles of size Y will be added for each nanoparticle of size X.

The reaction medium resulting from addition of the reaction medium obtained after step (b) to the suspension comprising nanoparticles of size Y in solvent S1′ is preferably left under agitation at a temperature between ambient temperature and the boiling point of the solvent mixture S1/S1′, preferably between 80° C. and the boiling point of the solvent S1/S1′, for sufficiently long time for grafting of the nanoparticles of size Y onto the surface of the nanoparticles of size X to take place. It is particularly possible to perform this grafting step at ambient temperature, typically between 15° C. and 40° C. Preferably the medium is left under agitation for a time of between 1 h and 72 h, preferably between 1 h and 24 h.

To promote adhesion between the particles during the reaction time, a catalyst can be added to the reaction medium such as dioctyltin dilaurate (DOTL). This step is optional.

The suspension obtained after step (c) therefore comprises raspberry nanoparticles of size X+2Y dispersed in the solvent mixture S1 and S1′.

As a function of grafting yield, the suspension obtained after step (c) may also comprise nanoparticles of size Y not grafted onto the RNPs, also dispersed in the solvent mixture S1 and S1′.

Step (d):

This step is optional. It may prove useful to promote later grafting of a hydrophobic molecule, whilst maintaining the dispersing properties of the particles at subsequent steps of the method.

The suspension of particles obtained after step (c) is diluted in a large volume of solvent S2. Typically, this volume corresponds to 1 to 10 times the initial volume of the suspension.

In one particular embodiment, the solvent S2 is a fluorinated solvent.

By «fluorinated solvent» it is meant a solvent or mixture of solvents of which at least one of the components is partially fluorinated or perfluorinated.

Preferably, the solvents of the invention comprise HFCs (hydrofluorocarbons), HFEs (hydrofluoroethers), HFOs (Hydrofluoroolefins), HCFOs (hydrochlorofluoroolefins), PFPEs (perfluoropolyethers).

According to one particular characteristic of the invention:
the hydrofluorocarbons are preferably hydrofluoro-(C3-6) alkanes, in particular pentafluorobutane (HFC-365-mfc),
the hydrofluoroethers are preferably (C1-4)alkoxy perfluoro-(C4-8) alkanes, in particular methoxy-nonafluorobutane (HFE-7100), ethoxy-nonafluorobutane (HFE-7200) and 1,1,1,2,2,3,4,5,5,5-decafluoro-3-methoxy-4-terfluoromethyl-pentane (HFE-7300),
the hydrofluoroolefins are preferably C3 to C10 containing a single double ethylene bond, in particular methoxy tridecafluoro heptene, and
the perfluoropolyethers are molecules having a C2 to C5 perfluorinated carbon chain interrupted by oxygen atoms, in particular the polymer of perfluoropropylene oxide.

In a further preferred embodiment, solvent S2 is an HFO, the mixture of isomers of 1,2,3,3,4,4,5,5,6,6,7,7,7-tridecafluoro-1-methoxy-Hept-1-ene [69296-04-04].

Optionally, solvent S1 and/or solvent S1′ are fully or partially removed from the suspension. Preferably, this removal is obtained by distillation, dialysis, filtration or centrifugation, in particular with several successive centrifugations. The supernatant mixture of solvents is removed whilst ensuring that the nanoparticles remain in liquid medium and are not desolvated, and said supernatant is removed and replaced by solvent S2. This process of centrifugation-supernatant removal-dilution can be repeated several times to cause the concentration of solvent S1 to tend towards zero and the concentration of solvent S2 towards 100%. On completion of this process, a suspension of nanoparticles dispersed in suspension in only solvent S2 can be obtained or in a solvent mixture S1 and/or S1′ with S2.

Therefore, at this step the nanoparticles are never desolvated and remain at all times in liquid medium.

Step (e):

After step (d), a suspension comprising raspberry nanoparticles of size X+2Y less than or equal to 130 nm dispersed in solvent S1, S1′, S2 or mixtures thereof is obtained.

In one particular embodiment of the invention, this suspension may also comprise non-grafted nanoparticles of size Y that are also dispersed in solvent S1, S1′, S2 or mixtures thereof.

In this suspension, the mean hydrodynamic diameter of the raspberry nanoparticles is less than twice their nominal diameter, allowing demonstration of absence of aggregates. The mean hydrodynamic diameter of the raspberry nanoparticles of the suspension obtained after step (e) of the invention is therefore typically always less than 260 nm.

One subject of the invention therefore concerns the suspension able to be obtained or directly obtained after step (e).

In one particular embodiment of the present invention, the method of the invention may comprise subsequent successive steps (f) and (g) after step (e), at which the raspberry nanoparticles are functionalised with at least one hydrophobic molecule. In this case, the method comprises the steps (a) to (e), and after step (e) comprises the following successive steps:
(f) Adding at least one hydrophobic organic molecule comprising a grafting function to the suspension recovered at step (e);
(g) Recovering a suspension of raspberry nanoparticles having a diameter of size X+2Y less than or equal to 130 nm functionalised with at least one hydrophobic organic molecule in solvent S1, S1′, S2 or mixtures thereof.

At steps (f) and (g), the raspberry nanoparticles are functionalised by at least one hydrophobic organic molecule so that they are coated with a hydrophobic layer, preferably monolayer, on the nanoparticle surface.

Contrary to document WO2015177229A2 in which the depositing of hydrophobic organic molecules is performed at an additional surface treatment step after deposition of the particles, the inventors have succeeded in developing a method which allows the surface of the nanoparticles themselves to be treated when they are in suspension in one of the solvents of the method and before they are deposited on a surface. The covalent nature of the bond between the constituent elementary particles of the RNPs permits the addition of at least one hydrophobic organic molecule or of a solution comprising at least one hydrophobic organic molecule to the suspension obtained after step (e), so that at least one hydrophobic organic molecule is grafted onto the surface of the raspberry nanoparticles without disrupting the structure thereof.

The particles obtained after step (e) can be deposited on a surface at a first step to give superhydrophilic surfaces. They can also be subsequently hydrophobized by hydrophobic molecules such as described in document WO2015177229A2.

Step (f):

The hydrophobic organic molecule comprising a grafting function exhibits reactivity with the nanoparticles of the method. It is a monomeric molecule capable of arranging itself in self-assembled monolayers on the surface of the particles. This molecule must form strong bonds with the surface, preferably covalent bonds.

By «monomeric molecule», it is meant a molecule of molecular weight not exceeding 2000 g/mol and having polarity enabling it to self-organise on the surface of the particles. With this definition, monomeric molecules can include some repeat units (oligomers) to impart the hydrophobic function (see general formula of the molecule below).

The general formula of the hydrophobic molecule of the invention is A-B-C, where:
A is a grafting function i.e. a group promoting adhesion of the molecule onto the surface of the nanoparticle,
B is a linker, and
C is a functional group imparting a hydrophobic and/or oleophobic nature to the formed layer of molecules.

In one preferred embodiment, group A is selected from among:
a) a silane group of formula:

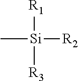

where R₁, R₂, and R₃ are each independently a halogen, typically a chlorine, bromine or iodine, a hydroxyl group OH, (C₁-C₁₀) alkyl group or (C₁-C₁₀)-alkoxy group, provided that when a substituent among R₁, R₂ and R₃ is a (C₁-C₁₀) alkyl group, then the two other substituents differ from a (C₁-C₁₀) alkyl group.

By «(C₁-C₁₀) alkyl» in the present invention, it is meant a linear or branched, saturated hydrocarbon chain having 1 to 10 carbon atoms. In particular, it is a methyl, ethyl or isopropyl, particularly a methyl.

By «(C₁-C₁₀)-alkoxy» in the present invention, it is meant a(C₁-C₁₀) alkyl group linked to the remainder of the molecule via an oxygen atom. In the present invention, it is in particular a methoxy, ethoxy or isopropoxy group.

Preferably R₁, R₂, and R₃ are the same and are a (C₁-C₁₀)alkoxy group,
b) a thiol group of formula —SH, or
c) a phosphonate group of formula:

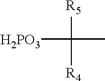

where:
R4 is a hydrogen H or fluorine F atom, or OH group, and
R5 is a hydrogen H or fluorine F atom, or PO₃H₂ group.

In one preferred embodiment, group B is a group L-M where:
L is a group (CH₂)ₘ—Z—, m being an integer of between 0 and 100, preferably between 0 and 30, and Z is a saturated or unsaturated, perfluorinated or partially fluorinated C₀-C₁₀₀ alkyl group, the alkyl chain possibly being substituted or interrupted by 0 to 10 cycloalkyl or aryl groups which may or may not be perfluorinated; Z can also be a single covalent bond, one of groups-(O—CH₂—CH₂)_{m′}, —(O—CH₂—CH₂—CH₂)_{m′}, —(O—CH₂—CH(CH₃))_{m′}, —(O—CH(CH₃)—CH₂)_{m′}, m′ being an integer of between 0 and 100, preferably between 0 and 50, and
M is selected from among:
   a) a single chemical bond, an oxygen atom, sulfur S atom, or a group S(CO), (CO)S, NR, (CO)NR, NR(CO), R being a hydrogen atom or C₁-C₁₀ alkyl, or
   b) the following groups:

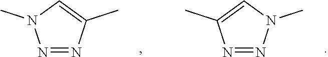

In one preferred embodiment, group C is selected from among a hydrogen atom, —(CF(CF₃)CF₂O)ₙ—CF₂—CF₂—CF₃, —(CF₂CF(CF₃)O)ₙ—CF₂—CF₂—CF₃, —(CF₂CF₂CF₂O)ₙ—CF₂—CF₂—CF₃, —(CF₂CF₂O)ₙCF₂—CF₃, —CF(CF₃)—O—(CF(CF₃)CF₂O)ₙ—CF₂—CF₂—CF₃, —CF(CF₃)—O—(CF₂CF(CF₃)O)ₙ—CF₂—CF₂—CF₃, —CF(CF₃)—O—(CF₂CF₂CF₂O)ₙ—CF₂—CF₂—CF₃, —CF₂—O—(CF₂CF₂O)ₙ—CF₂CF₃ or CₚF₂ₚ₊₁, where n and p are integers of between 1 and 100, preferably between 1 and 50.

Preferably, the hydrophobic organic molecule is a fluorinated molecule i.e. comprising at least one fluorine atom.

In one further preferred embodiment, the hydrophobic molecule has the formula A-B-C where: A is a silane group of formula:

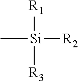

where R₁, R₂, and R₃, are each independently a halogen, typically chlorine, bromine or iodine, a hydroxyl group OH or (C₁-C₁₀)-alkoxy group.
B is a group L-M where:
L is a group (CH₂)ₘ—Z—, m being an integer of between 0 and 100, preferably between 1 and 30, more preferably between 1 and 10, and
M is a group NR, (CO)NR, NR(CO), R being a hydrogen atom or C₁-C₁₀ alkyl and

C is a one of groups —(CF(CF₃)CF₂O)ₙ, CF₂—CF₂—CF₃, —(CF₂CF(CF₃)O)ₙ—CF₂—CF₂—CF₃, —(CF₂CF₂CF₂O)ₙ—CF₂—CF₂—CF₃, —(CF₂CF₂O)ₙCF₂—CF₃, —CF(CF₃)—O—(CF(CF₃)CF₂O)ₙ, CF₂—CF₂—CF₃, —CF(CF₃)—O—(CF₂CF(CF₃)O)ₙ—CF₂—CF₂—CF₃, —CF(CF₃)—O—(CF₂CF₂CF₂O)ₙ—CF₂—CF₂—CF₃, —CF₂—O—(CF₂CF₂O)ₙ—CF₂CF₃ or CₚF₂ₚ₊₁— where n and p are integers of between 1 and 50, preferably between 1 and 30. Preferably, C is a group —CF(CF₃)—O—(CF₂CF(CF₃)O)ₙ—CF₂—CF₂—CF₃, n particularly being between 1 and 4.

In one still further preferred embodiment, the hydrophobic molecule has the structural formula:

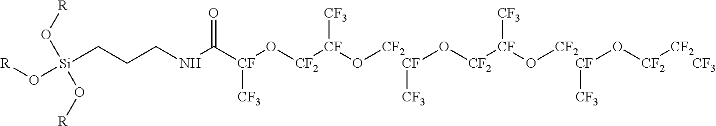

where R is a (C₁-C₄) alkyl group, preferably a methyl or ethyl.

This molecule, once deposited on particles having been subjected to the method of the invention, increases the hydrophobicity and oleophobicity thereof in most advantageous manner.

When the hydrophobic organic molecule comprises at least one fluorine atom, solvent S2 is preferably a fluorinated solvent such as defined above.

At step (f), a molecule or mixture of molecules corresponding to the above definition A-B-C can be added to the suspension obtained after step (e). Preferably, a single hydrophobic organic molecule is added.

The hydrophobic organic molecule(s) can be added at step (f) in a quantity Q which allows the coating of a surface of between 1 and 10 times the available surface on the raspberry nanoparticles, and optionally the particles of size Y in the suspension obtained after step (e).

By «available surface» it is meant the developed surface area of the nanoparticles capable of receiving grafting of the hydrophobic molecules. It is known to skilled persons that a molecule capable of forming self-assembled monolayers occupies an imprint on the surfaces onto which they are grafted. Quantity Q therefore represents the ratio between the developed surface A1 of the particles and surface A2 of the estimated imprint of a hydrophobic molecule. When the ratio A1/(Q*A2)=1, then the quantities are said to be stoichiometric.

Preferably quantity Q is equal to 1 (the molecule is added in stoichiometric quantity). Following the addition of the hydrophobic organic molecule(s) to the suspension obtained after step (e), the resulting reaction medium is typically left under agitation for a period of 1 to 48 h, preferably 6 to 24 h. The reaction can be conducted at a temperature of between 10° C. and the boiling point of the solvent of the suspension, typically between 10° C. and 150° C. For example, the temperature corresponds to ambient temperature or the reflux temperature of the medium. Preferably it is the reflux temperature.

By ambient temperature in the present invention, it is meant a temperature of between 10° C. and 40° C., preferably between 18° C. and 25° C.

When the organic molecule(s) are added in excess relative to the raspberry nanoparticles having a diameter of size X+2Y and optionally relative to the nanoparticles having a diameter of size Y, the method advantageously comprises an intermediate step (f′) between steps (f) and (g) at which the excess hydrophobic organic molecule is removed. For example, this removal is performed by centrifugation, particle sedimentation and successive renewals of the solvent of the suspension.

By particle sedimentation it is meant a step which accelerates sedimentation of the particles to form a deposit of particles at the bottom of a container, so that it is subsequently possible to remove the supernatant liquid. In this case, the deposit always remains in a minimum volume of solvent coating the particles. The addition of a fresh quantity of solvent allows re-suspension of the particles and repeating of the centrifuging step. Particle sedimentation therefore allows changing of all or part of the solvent in which the particles were initially contained.

The nanoparticles are therefore never desolvated throughout steps (f) to (g) and therefore always remain in liquid medium.

Step (g):

After step (g), a suspension is obtained comprising raspberry nanoparticles of size X+2Y less than or equal to 130 nm, functionalised with at least one hydrophobic organic molecule, dispersed in solvent S1, S1′, S2 or mixtures thereof. Said hydrophobic organic molecule grafted onto the surface of the raspberry nanoparticles forms a hydrophobic layer on the surface of said nanoparticles. In one particular embodiment of the invention, this suspension may further comprise nanoparticles of size Y also functionalised with at least one hydrophobic organic molecule and dispersed in solvent S1, S1′, S2 or mixtures thereof. Said hydrophobic organic molecule grafted onto the surface of the nanoparticles of size Y forms a hydrophobic layer on the surface of said nanoparticles. In this suspension, the mean hydrodynamic diameter of the raspberry nanoparticles is less than twice their nominal diameter, allowing demonstration of absence of aggregates. The mean hydrodynamic diameter of the raspberry nanoparticles of the suspension obtained after step (g) of the invention is therefore typically always less than 260 nm.

One subject of the invention therefore concerns the suspension obtained after step (g).

Use of the Suspensions of the Invention

The present invention also concerns the use of the suspension obtainable or directly obtained after step (e) of the method, to make a surface superhydrophilic.

By «superhydrophilic» in the present invention, it is meant a material giving contact angles with water of less than 10°, preferably less than 5°. The contact angle is measured by depositing a drop of water on a planar surface of the material and measuring the angle of the tangent of the droplet with the material.

A further subject of the invention concerns the use of the suspension obtainable or directly obtained after step (g) of the method, to make a surface superhydrophobic.

By «superhydrophobic» in the present invention it is meant a material giving contact angles with water greater than 150°. The contact angle is measured by depositing a drop of water onto a planar surface of the material and measuring the angle of the tangent of the droplet with the material. The suspensions of the invention can be applied to the surface of a large variety of materials. In particular, they can be transparent surfaces. The suspensions of the invention do not affect the transparency of the surface on which they are deposited. They can also be applied to non-transparent surfaces without harming their colouring.

In particular, this surface can be composed of a carbon-containing composite (graphene, carbon nanotubes, SiC, SiN, SiP, graphite), a polymeric material, a metal, an alloy or metal oxide. In addition, it can be a composite of polymeric organic materials and inorganic materials. It can also be applied to organic materials such as wood or cotton.

More particularly, this surface can be in steel, stainless-steel, indium tin oxide (ITO), zinc, zinc sulfide, aluminium, titanium, gold, chromium or nickel. Alternatively, this surface can be composed of silicon, aluminium, germanium and/or oxides and/or alloys thereof such as quartz, borosilicate glass such as BK7, or soda-lime glass. It can also be composed of polycarbonate (PC), polyethylene terephthalate (PET), polymethyl methacrylate (PMMA), polyamides (PA), polyvinyl alcohols (PVAI), polystyrene, polyethylene (PE), polypropylene (PP), polyvinyl acetate (PVA), poly (lactic acid), polyglycolic acid, polyester, poly(acrylic acid) (PAA), polyacrylate, polyacrylamide (PAM), polyalkyl acrylate, poly(methyl)acrylate (PMA), polyethyl acrylate (PEA), polybutyl acrylate (PBA), poly(methacrylic acid) (PMAA), polymethacrylate, polytetrafluoroethylene (PTFE), polyacrylonitriles (PAN), polyvinyl chlorides (PVC) or polyvinylidene fluorides(PVDF), in particular of polycarbonate, of polymethyl methacrylate (PMMA), polypropylene, polyvinyl acetate (PVA), polyamides (PA), polyethylene terephthalate (PET), polyvinyl alcohols (PVAI), polystyrenes (PS), polyvinyl chlorides (PVC) or polyacrylonitriles (PAN). These different polymeric materials possibly being present in a mixture or in the form of copolymers.

In one preferred embodiment, the suspensions of the invention are applied to a surface composed of at least 50%, preferably at least 75% silica, aluminium, germanium, the oxides or alloys thereof. Ideally, it is a surface with 100% content of these compounds. In one preferred embodiment, the surface is transparent, in glass or silica, in PMMA or polycarbonate.

The surfaces thus treated can be used in different applications, for example in optical or optronic equipment (display systems, lenses, glassed openings, eyewear, protective visors, helmet visors), renewable energy (solar panels), building materials (doors and windows), automotive or aerospace industries, windscreens, rear-view mirrors or telecommunications (e.g. for radars).

The surfaces thus treated can particularly be used in liquidophobic, anticorrosion, anti-frost or anti-soiling applications in industrial sectors such as cryogenics, aeronautics, wind energy or the cycling industry.

Alternatively, the surfaces thus treated can be used in particular in liquidophilic, anti-condensation, anti-misting, wetting applications.

Surface Coating Method

A further subject of the invention concerns a method for coating a surface such as defined above, whereby a suspension such as defined above is deposited on a surface, in a single step.

The object of this method is therefore to make a surface rough and superhydrophilic when depositing a suspension obtainable or directly obtained after step (e) of the above method, or to make a surface rough and superhydrophobic when depositing a suspension obtainable or directly obtained after step (g) of the above method.

By «single step» in the present invention it is meant that the surface is coated directly by depositing a layer of suspension of the present invention. Surface coating is obtained in a single application of only one formulation/suspension without any subsequent step. No annealing is necessary to obtain the expected effect.

The stability of the suspensions obtained also allows storage thereof for several days, preferably several weeks, more preferably several months. This means that it is not necessary to prepare suspensions extemporaneously at the time they are to be applied to a surface.

Depositing of the suspensions on the surface to be treated can be performed for example by immersion, by dip-coating, spin coating, spraying, flow-coating, or wiping.

By «dip coating», it is meant a deposition means whereby the surface to be treated is immersed and then withdrawn from a solution/suspension at a defined speed (L. D. Landau, V. G. Levich, Acta physicochimica, URSS, 17, (1942), 42).

By «spin coating», it is meant a deposition means whereby a solution/suspension is deposited on the surface to be coated. This same surface is attached to a turntable causing it to rotate at controlled speed allowing the solution/suspension to spread over the surface and to wet the entirety thereof (D. Meyerhofer, J. Appl. Phys., 49, (1978), 3993).

By «spraying» it is meant a deposition means whereby the solution/suspension is sprayed in fine droplets onto the surface. The sprayed suspension is projected onto the surface so that it wets the entirety thereof.

By «flow-coating» it is meant a deposition means whereby the solution/suspension is poured onto the surface to be coated so that it coats the entirety thereof.

By «wiping», it is meant a deposition means whereby a fabric, paper or brush impregnated with the solution/suspension to be deposited is applied to the surface to be treated. The fabric or paper is rubbed on the surface to wet the entirety thereof.

In one particular embodiment, the suspensions are deposited on the surfaces by dip-coating at a speed of between 1 and 500 mm/min, preferably between 5 and 150 mm/min with a period of stationary immersion of between 0 and 300 minutes. Preferably, deposition is performed at ambient temperature and allows layer thicknesses to be obtained of between 50 and 1000 nm, and preferably between 100 and 500 nm. Preferably, the dip-coating operations are repeated at least twice without affecting the transparency of the material.

In another particular embodiment, the suspensions are sprayed onto the surfaces to be coated. Advantageously, it is sufficient to conduct this operation only once to obtain a superhydrophilic or superhydrophobic surface.

### DESCRIPTION OF THE FIGURES

FIG. 1: NP15s in suspension in toluene, butyl acetate and MIBK according to Example 2.

FIG. 2: NP50s in suspension in toluene, butyl acetate and MIBK according to Example 2.

FIG. 3: NP100s in suspension in toluene, butyl acetate and MIBK according to Example 2.

FIG. 4: NP50s and NP15s in suspension in MIBK, without a drying step of the NPs according to Example 3.2.

FIG. 5: SEM images of the formulation of 130 nm RNPs in toluene according to Example 4.1.

FIG. 6: suspensions of RNP80s derived from different synthesis modes according to Example 6, in different solvents.

FIG. 7: SEM images of RNP80s synthesised in MIBK according to Example 13.

### EXAMPLES

### Example 1: Dispersion of Dry Silica Nanoparticles in a Protic Solvent

1—Commercial silica particles (Nissan-Chem) of nominal diameter 15 nm, 50 nm and 100 nm (respectively NP15, NP50 and NP100) in suspension in IPA at 300 g/L were diluted in IPA to obtain a concentration of 1 g/L. These particles were therefore always kept in liquid medium.
2—In parallel, silica nanoparticles of nominal diameter 15 nm, 50 nm and 100 nm initially in suspension in isopropanol (IPA) were dried with a vane pump and resuspended in isopropanol (IPA) at a concentration of 1 g/L.

The solutions were agitated with a magnetic agitator, sonicated for 30 minutes, then agitated 30 minutes with the magnetic agitator to disperse the nanoparticles and prevent aggregates.

The mean hydrodynamic diameter of the particles obtained at 1) and 2) was measured by dynamic light scattering using Zetasizer Nano Series ZS apparatus by Malvern.

| | | Mean hydrodynamic diameter | |
|---|---|---|---|
| 1- Particles before drying | NP15 | 38 ± 24 | nm |
| | NP50 | 74 ± 1 | nm |
| | NP100 | 123 ± 1 | nm |
| 2- Dried, resuspended particles | NP15 | 6082 ± 4900 | nm |
| | NP50 | 83 ± 1 | nm |
| | NP100 | 130 ± 1 | nm |

The mean diameter of the particles before drying is close to their nominal value (to within the hydrodynamic radius). DLS is therefore a suitable method for measuring the diameter of the nanoparticles and to estimate their dispersion.

After drying and resuspending in IPA, the mean diameter of NP50s and NP100s is close to their nominal value (to within the hydrodynamic radius) and is similar to the diameter obtained from particles which had remained in liquid medium.

In Case 2, resuspending in IPA of NP15s leads to very high measurements of mean hydrodynamic diameter (>6000 nm). Redispersion is poor on account of aggregates that have formed. It was not possible to remove these aggregates by agitation and sonication even when using a solvent promoting dispersion of silica nanoparticles (IPA).

This example shows that aggregation of particles increases with a decrease in their diameter and shows the difficulty and even impossibility of deagglomerating nanoparticles of small diameter. This justifies the maintaining in liquid medium to promote good dispersion of nanoparticles of diameter less than 50 nm.

### Example 2: Dispersion of Dry Particles in Aprotic Solvents

Silica nanoparticles of nominal diameter 15 nm, 50 nm and 100 nm initially in suspension in isopropanol (IPA) were dried with a vane pump and redispersed in toluene, butyl acetate (BuAc) or methyl isobutyl ketone (MIBK) at a concentration of 20 g/L.

The suspensions were sonicated for 30 minutes, agitated 1 h and left to stand for 60 hours.

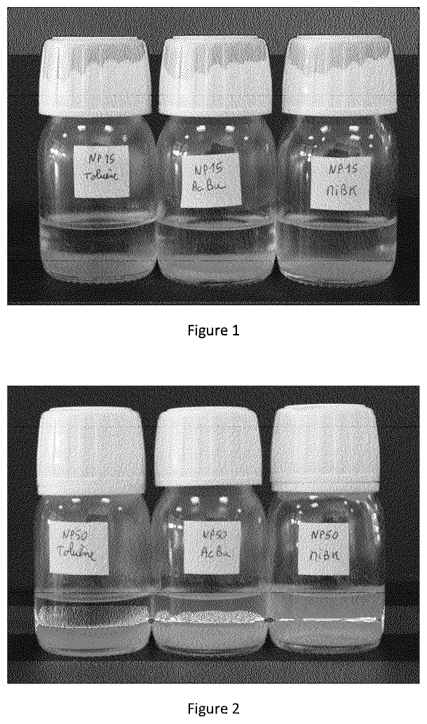

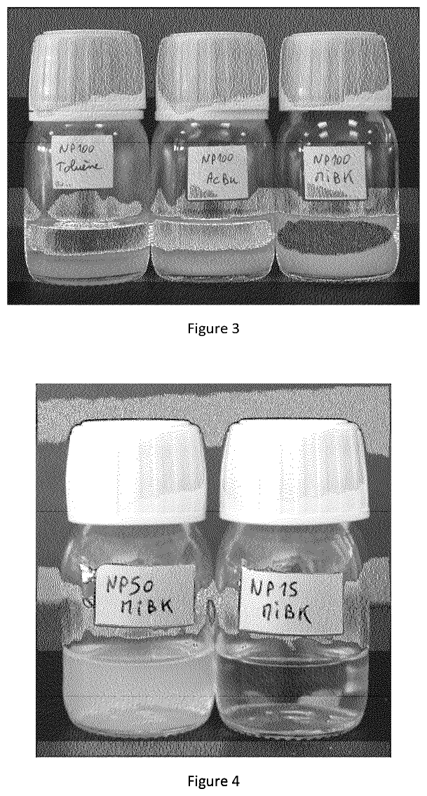

The stability of the suspensions was evaluated visually by observing settling of the particles and the presence or absence of a deposit at the bottom of the container (FIG. 1, FIG. 2 and FIG. 3). Irrespective of the solvent used, the NP15s settle to form a deposit at the bottom of the bottle (see FIG. 1).

NP50s fully settle in toluene. Settling is partial in butyl acetate and MIBK. Nevertheless, a deposit is seen at the bottom of the bottles (see FIG. 2).

NP100s settle in toluene and butyl acetate. The suspension of NP100s is stable in MIBK (see FIG. 3).

This example shows the difficulty of resuspending nanoparticles of diameter ≤50 nm in aprotic solvents. This justifies maintaining thereof in liquid medium to promote good dispersion of nanoparticles of diameter less than or equal to 50 nm.

### Example 3: Substitution of a Polar Solvent by an Apolar Solvent Keeping the Silica Nanoparticles in Liquid Medium

### Example 3.1: Nanoparticles (NPs) of Diameter 15 nm

A 500 mL three-necked flask was charged with:
10 mL of suspension of silica NP15s at 300 g/L in IPA
130 mL of solvent A

Solvent A was either toluene, or butyl acetate or methyl isobutyl ketone (MIBK). 90 mL of solvent were distilled to remove IPA and part of solvent A. In this manner the NP15s were moved from a suspension in a protic solvent to a suspension in an aprotic solvent without a desolvation step.

### Example 3.2: Particles of Diameter 50 nm

A 500 mL three-necked flask was charged with:
10 mL of suspension of silica NP50s at 300 g/L in IPA
150 mL of solvent A

Solvent A was either toluene, or butyl acetate or methyl isobutyl ketone (MIBK).

100 mL of solvent were distilled to remove IPA and part of solvent A. In this manner, the NP50s were moved from a suspension in a protic solvent to a suspension in an aprotic solvent without a desolvation step.

This example allows the initially protic solvent to be fully replaced by an aprotic solvent while remaining in liquid medium.

The colloidal suspension of NP15s and NP50s thus obtained were homogeneous and showed no sign of settling, an indication of good dispersion of the nanoparticles.

The suspensions derived from Examples 3.1. and 3.2. were diluted in MIBK at 20 g/L (see FIG. 4). After 60 hours, no settling was visible. The suspension is therefore stable.

Compared with Example 2, the suspensions of NP50s and NP15s in MIBK are less turbid and do not show any deposit at the bottom of the flask. The maintaining in liquid medium is therefore essential to maintain good dispersion of particles of diameter less than 50 nm.

### Example 4: Synthesis of RNPs

### Example 4.1: RNP130s Synthesised in Toluene

Silica NP100s in suspension IPA were suspended in toluene following the protocol described in Example 3 to obtain a stable dispersion of the nanoparticles.

The adhesion promoter used was an isocyanate silane (CAS 15396-00-6). It was added in excess to the reaction medium. The reaction was conducted for 15 h at ambient temperature to obtain grafting of the molecule onto the NP100s.

The excess isocyanate silane that had not reacted was removed by centrifugations, particle sedimentation and successive washings with toluene. The particles were resuspended in toluene. The NP100s functionalised by isocyanate silane were added to a suspension of silica NP15s in toluene obtained such as described in Example 3. The reaction medium was brought to 120° C. overnight to graft the silica NP15s onto the NP100s carrying reactive functions.

This protocol allows the obtaining of RNP130s in a mixture with non-grafted NP15s in suspension in toluene. At no time in this process are the NP15 particles desolvated.

SEM images of the formulations applied to the surfaces confirm the presence of dispersed raspberry nanoparticles (see FIG. 5).

### Example 4.2: RNP80s Synthesised in MIBK

Silica NP50s in suspension in IPA were placed in suspension in MIBK following the protocol described in Example 3.2. to obtain a stable dispersion of the nanoparticles.

Isocyanate silane (CAS 15396-00-6) was added in stoichiometric amount to the suspension of silica NP50s in MIBK. The reaction was conducted for 15 h at ambient temperature to obtain grafting of the molecule onto the NP50s.

The NP50s functionalised by the isocyanate silane were then added to a suspension of silica NP15s in MIBK obtained such as described in Example 3.1. The reaction medium was brought to 110° C. overnight to graft the silica NP15s onto the NP50s carrying reactive functions.

This protocol allows the obtaining of RNP80s in a mixture with non-grafted NP15s in suspension in MIBK. At no time of this process are the NP15 particles desolvated.

### Example 5: Syntheses of RNP80s. Comparison of the Method of the Invention with the Prior Art Method Described in Application WO2015177229

### Example 5.1: RNP80s Synthesised with the Method of the Invention

Isocyanate silane (CAS 15396-00-6) was added in stoichiometric amount to a suspension of silica NP50s in PMA. The reaction was conducted for 15 h at 30° C. to obtain grafting of the molecule onto the NP50s.

The NP50s functionalised by isocyanate silane were then added to a suspension of silica NP15s in PMA. The reaction medium was brought to 80° C. for 24 h to graft the silica NP15s onto the previously functionalised NP50s.

This protocol allows the obtaining of RNP80s in a mixture with non-grafted NP15s in suspension in PMA according to the protocol of the invention.

At no time in this process were the NP15 particles desolvated.

### Example 5.2: RNP80s Synthesised from Dry Particles

RNP80s were synthesised under the same conditions as described in Example 11.3. of application WO2015177229.

In a 100 mL anhydrous round-bottom flask equipped with a coolant under argon, 1 g of dry NP50s were placed in suspension in 30 mL of extra-dry toluene. The mixture was immersed in a sonication bath for 30 min then placed under magnetic agitation. 600 mg isocyanate silane (CAS 15396-00-6) were added using a syringe and the reaction medium was left under agitation overnight at ambient temperature. The mixture was centrifuged and the supernatant discarded. This step was carried out 3 times. The particles were then vacuum dried at 50° C. for several hours.

A 50 mL anhydrous round-bottom flask equipped with a coolant was charged under argon with 0.93 g of dry functionalised NP50s, 20 mL of extra-dry toluene and 0.67 g of dry NP15s. After sonication, the reaction medium was left under agitation and under reflux for 15 hours. This protocol allows the obtaining of RNP80s in a mixture with non-grafted NP15s in suspension in toluene, following the protocol described in WO2015177229.

This suspension was obtained from dry NP50s and NP15s.

### Example 6: Stability of RNP80 Suspensions

Five suspensions were prepared from RNP80s derived from Examples 5.1 and 5.2:
1. Particles derived from 5.2 diluted at 20 g/L in 100% of toluene.
2. Particles derived from Example 5.2 vacuum dried and then dispersed at 20 g/L in 100% of toluene.
3. Particles derived from Example 5.2 diluted at 20 g/L in 20% of toluene (derived from synthesis) and 80% of PMA
4. Particles derived from Example 5.2 vacuum dried and then dispersed at 20 g/L in 100% of PMA
5. Particles derived from Example 5.1 diluted at 20 g/L in 100% of PMA

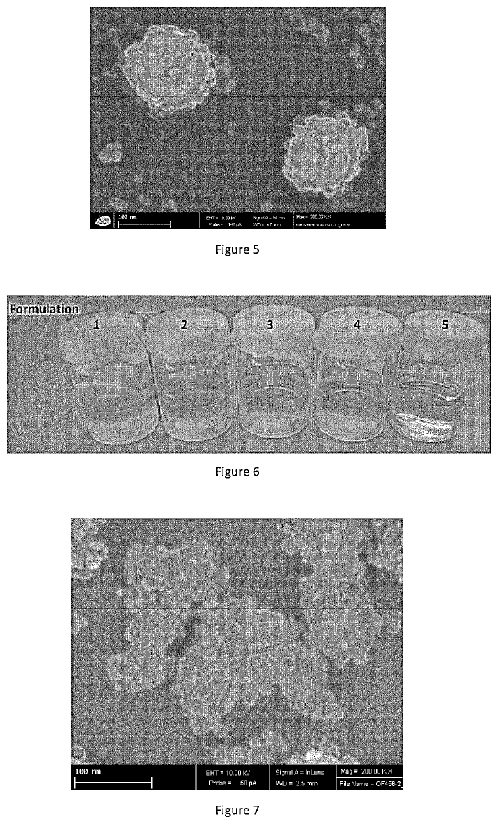

Suspensions 1 to 5 were sonicated and agitated then left to settle at ambient temperature for 15 days (see FIG. 6).

Suspensions 1 to 4, obtained with RNP80s synthetized from dry NP15s and dry NP50s are cloudy and a particle sedimentation layer can be seen as the bottom of the pill bottle. This indicates the presence of aggregates of large size which do not allow a colloidal suspension to be obtained. These suspensions are therefore not stable. As shown in Example 2, the aggregates are mostly derived from NP15s which were unable to be redispersed.

On the contrary, formulation 5 is limpid and no deposit can be seen at the bottom of the pill bottle, indicating that it does not settle. It is obtained with RNP80s synthesised with the method of the invention in which the NP15s are never desolvated. With this method, it is therefore possible to obtain a colloidal suspension not containing aggregates of large-size particles.

This experiment confirms that the suspensions obtained with RNP80s synthesised with the method of the invention, not requiring desolvation at any time of NP15s, are structurally different since much more stable than the suspensions obtained with the method described in WO2015177229.

### Example 7: Syntheses of RNP130s. Comparison of the Method of the Invention with the Prior Art Method Described in Application WO2015177229

### Example 7.1: RNP130s Synthesised with the Method of the Invention

Isocyanate silane (CAS 15396-00-6) was added in stoichiometric amount to a suspension of silica NP100s in PMA. The reaction was conducted for 15 h at 30° C. to obtain grafting of the molecule onto the NP100s.

The NP100s functionalised by isocyanate silane were added to a suspension of silica NP15s in PMA. The reaction medium was brought to 80° C. for 24 h to graft the silica NP15s onto the previously functionalised NP100s.

This protocol allows the obtaining of RNP130s in a mixture with non-grafted NP15s in suspension in PMA, following the protocol of the invention.

At no time of this process are the NP15 particles desolvated.

### Example 7.2: RNP130s Synthesised from Dry Particles

RNP130s were synthesised by reproducing Example 11.3. of patent application WO2015177229. A 100 mL anhydrous round-bottom flask equipped with a coolant was charged under argon with dry NP100s in extra-dry toluene. The mixture was immersed in a sonication bath for 30 min then placed under magnetic agitation. Isocyanate silane (CAS 15396-00-6) was added in excess using a syringe and the reaction medium was left under agitation overnight at ambient temperature. The mixture was centrifuged and the supernatant discarded. This step was performed 3 times. The particles were then vacuum dried at 50° C. for several hours.

A 50 mL anhydrous round-bottom flask equipped with a coolant was charged under argon with the dry functionalised NP100s, extra-dry toluene and the dry NP15s. After sonication, the reaction medium was left under agitation 15 hours under reflux. This protocol allows the obtaining of RNP130s in a mixture with non-grafted NP15s in suspension in toluene, as described in WO2015177229.

This suspension was obtained from dry NP100s and NP15s.

### Example 8: Stability of Suspensions of RNP130s

Five suspensions were prepared from the RNP130s obtained in Examples 7.1 and 7.2:
1. Particles derived from Example 7.2 diluted at 20 g/L in 100% of toluene.
2. Particles derived from Example 7.2 vacuum dried and dispersed at 20 g/L in 100% of toluene.
3. Particles derived from Example 7.2 diluted at 20 g/L in 20% of toluene (derived from synthesis) and 80% of PMA.
4. Particles derived from Example 7.2 vacuum dried then dispersed at 20 g/L in 100% of PMA.
5. Particles derived from Example 7.1 diluted at 20 g/L in 100% of PMA.

The suspensions were sonicated, agitated and left to stand for a few minutes.

Formulations 1 and 2 in toluene, obtained with RNP130s synthesised from dry NP15s and dry NP100s settle after a few minutes. The formulations are therefore not stable.

Formulations 3 and 4 in PMA, obtained with RNP130s synthesised from dry NP15s and dry NP100s are turbid. This is due to the presence of large-diameter aggregates in the formulation. As shown in Example 2, the aggregates are mostly derived from NP15s which were unable to be redispersed.

On the contrary, formulation 5 is limpid and not deposit can be seen at the bottom of the pill bottle. The particles in suspension are therefore of small diameter. There are no aggregates. This experiment confirms that the suspensions obtained with RNP130s synthesised with the method of the invention, at no time requiring desolvation of NP15s, are structurally different being more limpid than the suspensions obtained with the method described in WO2015177229.

### Example 9: Measurements of the Mean Hydrodynamic Diameter of RNPs

RNP80s were synthesised as a variant to Example 5.1, whereby the mixture of particles was heated to 110° C. in the presence of DOTL.

RNP130s were synthesised in toluene according to Example 4.1.

The formulations were diluted in isopropanol so that the proportion of synthesis solvent (PMA or toluene) was less than 5% by volume.

The hydrodynamic radii of the particles were measured by dynamic light scattering using a Zetasizer (Malvern).

| | Theoretical | Mean hydrodynamic | Polydispersity |
|---|---|---|---|
| | diameter | diameter | index |
| RNP80 | 80 nm | 128 nm | 0.071 |
| RNP130 | 130 nm | 185 nm | 0.165 |

Distribution of the hydrodynamic diameters of the raspberry nanoparticles RNP80 and RNP130 is monodisperse, as shown by the low polydispersity indices. The hydrodynamic diameter values obtained, comprising the diameter of the particle and the solvation layer thereof, tally with expected values. These two results show that the diameter of the RNPs is twice smaller than the nominal diameter of the particles, which is characteristic of the absence of aggregates.

### Example 10: Functionalisation of RPN130s by a Perfluoropolyether (PFPE) Silane

A PFPE trimethoxysilane of formula

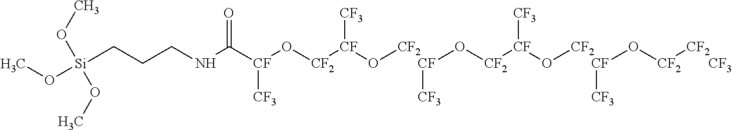

was dissolved in isopropanol containing raspberry nanoparticles 130 nm in diameter. The RNP130s were obtained by covalent grafting of NP15s onto NP100s following the protocol in Example 4.1. The mixture containing excess of the silane molecule was left under agitation overnight at ambient temperature.

The excess non-reacted silane was removed by centrifugations, particle sedimentation, and successive washings with Novec 7200 fluorinated solvent. The particles were resuspended in Novec 7200.

In this manner the particles are dispersed, are hydrophobic and always remain in liquid medium when removing the excess molecules and when changing the solvent.

### Example 11: Functionalisation of RNP80s by a Perfluoropolyether (PFPE) Silane

A hydrofluorolefin, a mixture of the isomers of 1,2,3,3,4,4,5,5,6,6,7,7,7-tridecafluoro-1-methoxy-Hept-1-ene [69296-04-04] (HFO), was added to the suspension of RNP80s and NP15s obtained in Example 4.2, to replace MIBK. The MIBK was removed by centrifugation to cause sedimentation of the particles and resuspension thereof to obtain a suspension of RNP80s and NP15s in HFO

A PFPE trimethoxysilane of formula:

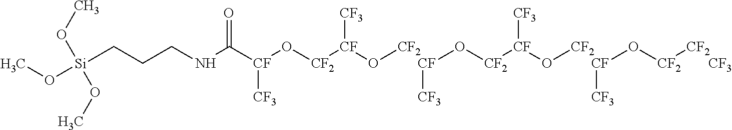

was added in stoichiometric amount to the suspension of nanoparticles in HFO.

The mixture was left under agitation overnight at 110° C.

This example allows the obtaining of hydrophobic, dispersed particles which remain in liquid medium throughout their preparation time and storage thereof.

### Example 12: Application of RNP80s to a Surface

RNP80s obtained in Example 4.2 were used to coat surfaces. The formulation was applied in 3 spray operations onto a glass surface and left to dry for one minute. The surfaces obtained were superhydrophilic.

After vapour phase hydrophobization by the molecule described in Example 5, the surfaces became superhydrophobic (AC_{H2O}=152°, tilt=8°).

### Example 13: Application of Hydrophobic RNP130s to a Surface

The hydrophobic RNP130s obtained in Example 10 were used to coat surfaces. The formulation was applied by dip-coating onto a glass surface and left to dry for one minute. The surfaces obtained are superhydrophobic (AC_{H2O}=156′).

### Example 14: Application of Hydrophobic RNP80s to a Surface

The hydrophobic RNP80s obtained in Example 11 were used to coat surfaces. The formulation was applied by spraying onto a glass surface and left to dry for one minute. The surfaces obtained are superhydrophobic (ACH2O=153°, tilt angle=1°). The RNP80s deposited on the surface can be seen in FIG. 7.

1. A method for preparing a suspension comprising raspberry nanoparticles having a diameter of size X+2Y, each raspberry nanoparticle being composed of a nanoparticle having a diameter of size X on the surface of which nanoparticles having a diameter of size Y are covalently grafted,
said method comprising at least the following successive steps:
(a) Obtaining a suspension comprising nanoparticles having a diameter of size X in an aprotic solvent S1;
(b) Adding an adhesion promoter to the suspension obtained after step (a) to obtain a first reaction medium;
(c) Adding the reaction medium obtained after step (b) directly to a suspension comprising nanoparticles having a diameter of size Y dispersed in an aprotic solvent S1′, leading to the formation of raspberry nanoparticles having a diameter of size X+2Y to obtain a second reaction medium;
(d) Optionally, adding a solvent S2 to the second reaction medium, then partially or fully removing aprotic solvent S1 and/or aprotic solvent S1′;
(e) Recovering a suspension of raspberry nanoparticles having a diameter of size X+2Y dispersed in the aprotic solvent S1, the aprotic solvent S1′, the solvent S2 or mixtures thereof,
wherein the nanoparticles having a diameter of size X or Y and the raspberry nanoparticles are kept in liquid medium throughout all the steps of the method,
and the diameter of size X+2Y of the raspberry nanoparticles is less than or equal to 130 nm, and
at least one of the diameters of size X or Y is of size less than 50 nm.

2. The method according to claim 1, wherein the ratio X/Y of the diameters is between 1 and 30.

3. The method according to claim 1, wherein the nanoparticles are composed of at least one inorganic material.

4. The method according to claim 1, wherein the adhesion promoter is an alkoxysilane or chlorosilane carrying a reactive function.

5. The method according to claim 1, wherein the nanoparticles having a diameter of size Y are added in excess at step (c) in relation to the nanoparticles having a diameter of size X.

6. A suspension obtainable by the method of claim 1, wherein the suspension contains raspberry nanoparticles having a diameter of size X+2Y less than or equal to 130 nm dispersed in the aprotic solvent S1, the aprotic solvent S1′, the solvent S2 or mixtures thereof.

7. The suspension according to claim 6, wherein the suspension also comprises nanoparticles having a diameter of size Y not grafted onto the nanoparticles of size X.

8. The method according to claim 1, further comprising after step (e) the successive steps:
(f) Adding at least one hydrophobic organic molecule comprising a grafting function to the suspension recovered at step (e);
(g) Recovering a suspension of raspberry nanoparticles having a diameter of size X+2Y less than or equal to 130 nm functionalised with the hydrophobic organic molecule in the aprotic solvent S1, the aprotic solvent S1′, the solvent S2 or mixtures thereof.

9. The method according to claim 8, wherein the hydrophobic organic molecule is a fluorinated molecule.

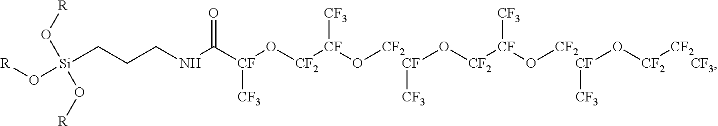

10. A suspension obtainable by the method of claim 8, wherein the suspension contains raspberry nanoparticles having a diameter of size X+2Y less than or equal to 130 nm, functionalised with said hydrophobic organic molecule, dispersed in the aprotic solvent S1, the aprotic solvent S1′, the solvent S2 or mixtures thereof.

11. The suspension according to claim 10, wherein further comprising nanoparticles having a diameter of size Y functionalised with a layer of hydrophobic organic molecules and dispersed in the aprotic solvent S1, the aprotic solvent S1′, the solvent S2 or mixtures thereof.

12. A method for making a surface superhydrophilic comprising the steps of:
(i) providing a surface, and
(ii) applying the suspension of claim 6 to the surface provided in step (i).

13. A method for making a surface superhydrophobic comprising the steps of:
(i) providing a surface
(ii) applying the suspension of claim 10 to the surface provided in step (i).

14. A method for coating a surface comprising the steps of:
(i) providing a surface
(ii) depositing on the surface provided in step (i) the suspension of claim 6 by dip-coating, spin-coating, spray, flow-coating or wiping.

15. (canceled)

16. A method for coating a surface comprising the steps of:
(i) providing a surface
(ii) depositing on the surface provided in step (i) the suspension of claim 10 by dip-coating, spin-coating, spray, flow-coating or wiping.

17. The method according to claim 2, wherein the ratio X/Y of the diameters is between 3 and 10.

18. The method according to claim 3, wherein the at least one inorganic material is silicon, aluminium, titanium, zinc, germanium, and/or the oxides and/or the alloys thereof.

19. The method according to claim 4, wherein the reactive function is an isocyanate function.

20. The method according to claim 9, wherein the fluorinated molecule is of following formula: 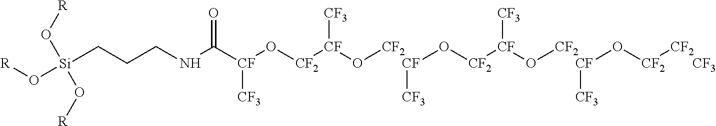
where R is a (C₁-C₄) alkyl group.
